(19) United States
(12) Patent Application Publication
(10) Pub. No.: US 2009/0112633 A1
(43) Pub. Date: Apr. 30, 2009

(54) Systems and methods for securitizing longevity risk

(76) Inventors: Harish Raghavan, New York, NY (US); Jamshid Ehsani, Greenwich, CT (US); Robert Thompson, Harrison, NY (US)

Correspondence Address: MCDERMOTT WILL & EMERY LLP, 600 13TH STREET, N.W., WASHINGTON, DC, 20005-3096, US

(21) Appl. No.: 12/220,685

(22) Filed: Jul. 24, 2008

Related U.S. Application Data
(60) Provisional application No. 60/961,864, filed on Jul. 25, 2007.

(51) Int. Cl. G06Q 40/00

(52) U.S. Cl. 705/4

(57) ABSTRACT

A system for structuring credit support in connection with life insurance premium finance loans and securitizing longevity risk includes a trust having a life insurance policy and a premium finance loan from a lender that finances the cost of the premiums of the life insurance policy. The life insurance policy is used as collateral for the premium finance loan. The trust provides to the lender additional collateral in the form of a letter of credit or other forms of collateral to cover any shortfall between the balance and the policy cash surrender value. A longevity risk fund provides the credit support by entering into a collateral support agreement with the trust through a credit source. The longevity risk fund receives compensation in the form of risk adjusted return on exposure, in exchange for providing the additional collateral. The cash flows received from the credit support obligations are then securitized through the transfer of the related collateral support agreements (either by legal transfer or economic participation) to a special purpose vehicle that issues securities (either equity or debt) to the capital markets.

### PRIORITY CLAIM

This application claims priority from U.S. provisional application Ser. No. 60/961,864 filed Jul. 25, 2007.

### TECHNICAL FIELD

The inventions disclosed herein generally relate to systems and methods for structuring credit support, and indirectly longevity risk, in connection with life insurance premium finance loans. The inventions also generally relate to systems and methods for securitizing such credit support and longevity risk. More specifically, the present inventions relate to systems and methods for structuring and securitizing credit support and longevity risk through investment arbitrage.

### BACKGROUND OF THE INVENTION

Over the last few years, capital markets investors have been exploring ways to diversify risk traditionally associated with exposure to fixed income, real estate, foreign exchange markets and commodities. As a result, significant financial resources continue to be available for use in alternative investment vehicles. One growth area has been the development of capital markets in the life insurance industry. Life Insurance as an asset class is generally considered uncorrelated to the other segments of the financial markets (i.e., because mortality events occur irrespective of the performance or condition of other economic metrics in the financial markets).

Premium finance and life settlements have been specific growth areas in the life insurance sector. Premium finance as used herein is the financing of premiums on insurance policies. Moreover, life settlements as used herein are life insurance policies sold by their owners to third parties in return for a lump sum payment.

One viable alternative approach is investment in life insurance through longevity arbitrage, which is being viewed by an increasing number of capital sources as an attractive alternative to traditional risk exposure. As a result, significant levels of capital has already been committed to, and deployed in, various longevity risk strategies. Traditionally, capital sources have primarily used the senior life settlement market to buy longevity exposure. Buying longevity exposure through the senior life settlement market, however, does not allow investors to effectively acquire the level of longevity assets necessary to achieve the desired diversification in their portfolios.

Moreover, the sharp increase in investor demand for life settlement policies combined with investor desire to purchase predominantly small face value policies for individuals having a shorter life expectancy and high carrier credit rating have resulted in significant price increases for this segment of the settlement market.

Accordingly, it would be desirable to provide systems and methods for investing in and securitizing longevity risk without significant exposure to the shortcomings of the existing senior life settlement market. Additionally, premium finance lenders generally require their premium finance loans to be fully secured by investment grade assets (i.e. letters of credit and the cash surrender value of the policies). Thus, it would be further desirable to optimally structure credit support in connection with such premium finance loans and then securitize the cash flows of such credit support.

### SUMMARY OF THE INVENTION

Systems and methods for securitizing longevity risk through direct and indirect investments that overcome constraints associated with the conventional longevity market are provided. The solutions described herein enable the securitization of longevity risk by acquiring and dynamically managing a diversified pool of life insurance-related products. One benefit of the present invention is that it does not require waiting for the realization of the death benefit of the insured to monetize the gains inherent in the portfolio of holdings. Further, the present invention provides returns that are not correlated to the equity, fixed income, commodity or real estate markets.

Generally speaking, the present invention may secure longevity assets by indirect investment in longevity risk by providing the insured with collateral to premium finance their policies. Due to the constraints associated with the senior life settlement market, the systems and methods of the present invention provide an approach in which is based largely on indirect investments.

Indirect investments may be based, at least in part, through the issuance of new or supplemental life insurance policies. The policies are generally issued as part of the insured's estate or financial planning.

In one embodiment of the present invention, a method for structuring investment vehicles that allow investors to securitize and invest in longevity risk is provided, comprising: creating a life insurance trust that holds a life insurance policy for an insured; obtaining a premium finance loan to finance the cost of the life insurance policy; pledging to the premium finance lender the life insurance policy as a collateral for the loan; and the posting of credit support with the premium finance lender by a credit support provider.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. The drawings disclose illustrative embodiments. They do not set forth all embodiments. Other embodiments may be used in addition or instead. In the figures, like reference numerals refer to the same or similar elements.

FIG. 1 is a block diagram illustrating a system for structuring credit support in connection with premium finance loans and securitizing longevity risk constructed in accordance with the principles of the present invention.

FIG. 2 is a flow chart illustrating some of the steps associated with a method for structuring such credit support in accordance with certain aspects of the present invention.

### DETAILED DESCRIPTION

The present inventions are directed toward systems and methods for structuring investment vehicles that allow investors to securitize and invest in longevity risk. It is contemplated that the subject matter described herein may be embodied in numerous forms. Accordingly, the embodiments described in detail below are illustrative of the inventions, and are not to be considered as limiting. Other specific embodiments, based on the principles of the inventions described herein, may be used if desired.

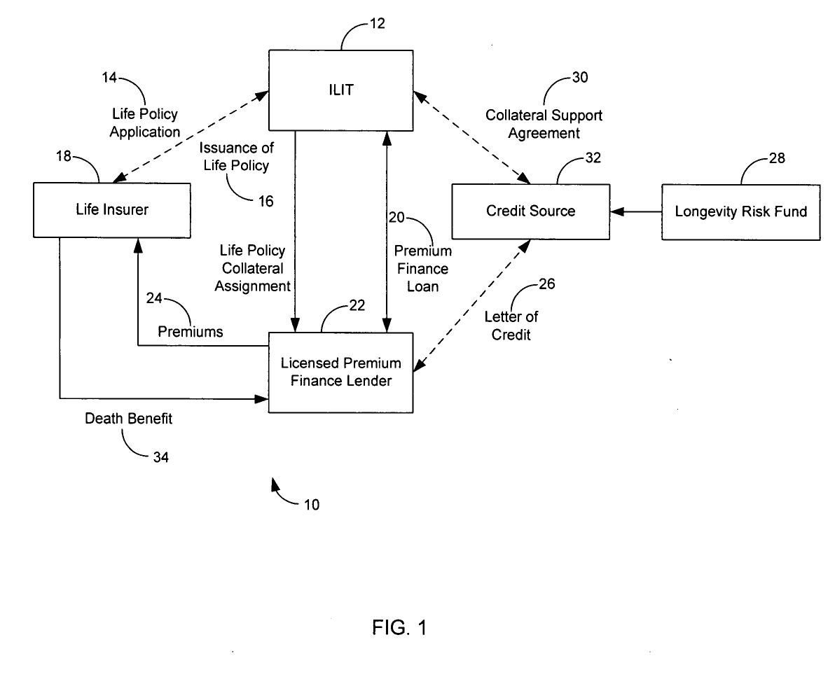

FIG. 1 illustrates a system 10 for structuring credit support in connection with life insurance premium finance loans and investment in and securitization of such longevity risk in accordance with one embodiment of the present invention. Longevity risk refers to the financial risk associated with the cost of initiating and/or maintaining a life insurance policy compared to the payout of its death benefit. Generally speaking, the longer insurance policy premiums are paid, the less valuable the death benefit becomes to the party paying the premiums (and vice versa). Thus, for example, in the case where a two million dollar life insurance policy is obtained, the profit received from the death benefit payout is greater to the party paying the premiums if such payments are paid for three years rather than nine years. This risk is the reciprocal of the mortality risk (i.e., risk of premature death) that a insurance carrier bears when it issues a life insurance policy.

System 10 may be configured as shown in FIG. 1, at least in part, by an investment manager, agent or company which establishes a longevity risk fund such as fund 28, to invest in longevity risk by providing credit support in connection with a premium finance loan issued by a premium finance lender. In one embodiment of the invention, system 10 may be configured as a computer program implemented one or more local (or remote) computers (not shown).

For example, an investment agent may create one or more computer programs, which may electronically communicate with the appropriate insured, entities or businesses (on an automatic or semi-automatic basis) to create and/or interact with the functional blocks generally shown in FIG. 1 in order to achieve the objectives of the invention as further described herein. Such a computer program may be resident, at least in part, on a server sponsored by fund 28.

At the outset, an insured or potential insured, may seek out through their agents, brokers or financial planners, fund 28 to participate in the systems described herein to further their estate or financial planning goals. However, any other suitable avenues of entry may be used if desired. For example, an investment entity such as fund 28 may locate or otherwise retain a party or person to be insured to participate in the investment. In some embodiments, the potential insured may respond to inquires or advertisements or initiate contact to participate in the process (and thereby obtain certain pecuniary benefits by virtue of that participation, as described below) Potential insured parties may also be actively sought by fund 28 or an associated party.

For example, the investing entity may seek out qualified persons who have no pre-existing life insurance to participate in the investment (new insurance). In this case, the ILIT established by the insured may apply for and secure life insurance for those persons as described below. In other embodiments, participants may have pre-existing life insurance, which may be pledged as collateral and used as the basis for the investment or estate planning needs of the insured In yet other embodiments, supplemental life insurance may be secured for those having some pre-existing life insurance to increase the total death benefit and the insured party to a desired level.

Initially, as shown in FIG. 1, an Irrevocable Life Insurance Trust (“ILIT”) 12 may be created by the insured, to further certain estate or financial planning goals. Thus, the party to be insured submits an application 14 for a life insurance policy 16 to an insurance company 18 (for new or supplemental policies). Such life insurance policies 16 may include whole life, term life or other life insurance as is known in the art.

Pre-existing life insurance polices, which may also be generally referred to as policy 16 herein and may also include whole, term or other insurance, bypass the application step. In some embodiments, insurance company 18 may be a highly-rated insurance company 18 to ensure death benefit payout and facilitate collateralization and/or obtain certain desirable enhanced life insurance benefits that are well known in the industry.

ILIT 12 obtains a premium finance loan 20 from a premium finance lender 22, which will be used to finance some or all policy premiums 24 on a fully collateralized basis. This loan may be used to pay premiums on the new, supplemental or pre-existing life insurance policies that are the subject of the credit support in FIG. 1. The general purpose of the loan is to relieve the insured from paying premiums and other costs associated with policy 16 prior to payment of the death benefit.

In some embodiments, the premium finance loan may be acquired to cover substantially all insurance premiums paid, closing fees, plus capitalized interest and may further include substantially all costs associated with maintaining policy 16 and ILIT 12. In other embodiments, some or all of the costs may be handled directly by fund 28 and/or the insured (not shown).

Furthermore, in many embodiments, lender 22 may continue to pay premiums on the premium finance loan contract until a specified maturity date or when death benefit is paid (and commit to this obligation prior to issuing the loan). In such embodiments, premium finance lender 22 typically pays the insurance premium and/or bills on behalf of person or company, for example, in monthly (quarterly or yearly) installments, for the cost of the loan.

However, in other embodiments, alternative loan periods, which may split the premium cost among one or more of the insured, fund 28 and/or lender 22 may be used if desired (e.g., in order to lower loan amounts and thereby increase the return to ILIT 12). In addition, the loan contract may be arranged for a preset period of time (e.g., 7 years). In such embodiments, lender 22 may pay an initial period (e.g., the first 5 years, etc.) with fund 28 and/or the insured paying the remaining premiums. If the fund 28 steps in to pay ongoing premiums, it would do so either as a replacement lender to the original lender 22 or as an assignee or subrogee of the original lender 22.

To collateralize the loan, ILIT 12 will pledge life insurance policy 16 as collateral to lender 22. In the case where a pre-existing life insurance policy is being used, only a portion of the death benefit of the pre-existing policy may be pledged as collateral as requested by lender 22. However, in the case where the life insurance policy 16 is new or supplemental, ILIT 12 will pledge the life insurance policy as collateral and arrange for additional collateral in order to secure the loan terms desired from lender 22 (e.g., to obtain more favorable loan terms, such as a lower interest rate, a longer loan term, etc.).

For example, as shown in FIG. 1, ILIT 12 may provide additional collateral in the form of a letter of credit 26 from a longevity risk fund 28. Other forms of collateral may be used if desired (e.g., posting cash). The collateral may be used to cover any shortfalls between the balance of the premium loan and the cash surrender value of the new or supplemental life insurance policy 16 (e.g, during an initial “ramp up” period).

As shown, longevity risk fund 28 may enter into a collateral support agreement 30 with ILIT 12 through a credit source 32, in order to provide the letter of credit. In other embodiments, fund 28 may replace source 32 either fully or partially, provide the collateral support agreement substantially directly. In such embodiments, credit source 32 may play a diminished role or be removed altogether (not shown).

In exchange for providing the additional collateral, the longevity risk fund 28 may receive compensation, such as a structuring fee, a collateral contingency fee and/or a makewhole. The structuring fee is paid by the borrower at inception and may be capitalized as part of the principal of the premium finance loan. The collateral contingent fee is a contingent fee payable by the borrower in exchange for the collateral support. In the event of certain enumerated events of default or if the borrower terminates the collateral support agreement or prepays the premium finance loan prior to maturity, the borrower may be obligated to pay a makewhole fee. Such fees may be paid prior to the payout of the death benefit, thus allowing fund 28 to monetize the investment at, or temporally proximate with, its inception.

Thus, when the insured dies, death benefit 34 is paid from insurer 18 to premium finance lender 22, which uses the proceeds to repay the principal, interest and fees on the premium finance loan 20.

The remaining death benefit 34 will then be paid to the trustee of ILIT 12, which disburses the remaining funds to credit source 32 and the beneficiaries of ILIT 12 (although other payouts are possible). It will be understood that the amounts paid to ILIT 12 (e.g., 15%, 25%, 45%, etc. of gross death benefit), will vary depending on how long the policy is financed. The greater the amount of leverage and collateral support, the smaller the percentage of death benefits will be received by the ILIT beneficiaries (and vice versa).

In the case where the payout is based on new or supplemental life insurance, ILIT 12 may pay the amounts described above. However, in the case where the payout is based largely on pre-existing insurance, the majority of the payout may go to the insured.

In the case where the insured dies earlier than expected, the remaining death benefit 34 is typically greater than if the insured survives for a significantly longer period of time (based on the number or premium payments made by the lender). In such cases, the majority of death benefit 34 may be paid to ILIT 12 and passed along to the insured for new and supplemental policies. For example, death benefit 34 may be paid on a sliding scale (e.g., about 60% of the death benefit 34 in year 1 paid to ILIT 12, adjusting to about 5% by year 7, 8, or 9, depending on the insured).

Some of the risks associated with system 10 may include one or more of the following risk characteristics: a mortality or longevity risk of the insured; a credit risk (e.g., the insurance company 18); a debt service risk (e.g., on the financing amount and ongoing premium 24 payments on the life insurance policy 16); and an operational risk.

These risks may be alleviated, at least in part, by closely considering the following parameters that affect the financial performance of system 10: life expectancy of the insured; the solvency and quality of insurance company 18 and underwriters; the minimum/maximum face amounts of the individual life insurance policy 16; the type of life insurance policy 16 (e.g., universal general account policies may be preferred with other types of policies, such as variable and term, considered on a case-by-case basis); the minimum number of lives insured (e.g., there may be a minimum of 200 lives insured); a cap on the percentage of the portfolio based on a single impairment (e.g., no single impairment, such as a disease category as a primary ailment affecting the insured, may be greater than 30% of the portfolio face); a limit on the insurance company 18 ratings (e.g., 100% investment grade; 90% 1-/A3 or better; 50% AA-/AA3 or better); minimum age of the insured (e.g., the insured must be at least 65 years old); servicing of structure and policies by an institutional servicer or trust company; and contestability may be reviewed and considered on a case-by-case basis.

Once fund 28 has accumulated sufficient cases of credit support, it may securitize the cash flows (i.e. structuring fees, collateral contingent fees and makewhole fees) it expects to receive from the structure. The securitization may encompass a structure whereby the credit support fees are transferred (either through legal sale of the related collateral support agreements or through economic participation of such fees) to a bankruptcy-remote special purpose vehicle that will then issue securities (either in the form of debt or equity) to the capital markets.

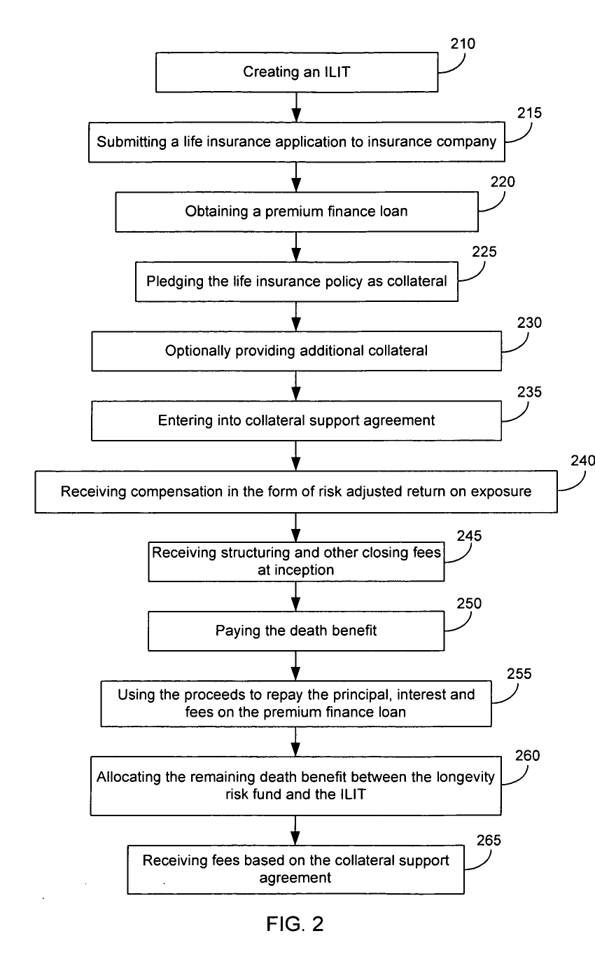

FIG. 2 illustrates a method 200 for the structuring of the credit support in accordance with one embodiment of the present invention. As shown in FIG. 2, the method of structuring the credit support may include the following steps: creating an ILIT 12 (step 210); submitting an application 14 for a life insurance policy 16 to insurance company 18 (step 215); obtaining a premium finance loan 20 with lender 22 (step 220) which may be used to finance some or all of the costs associated with policy premiums 16 on a fully collateralized basis.

Next, policy 16 may be pledged as collateral for the premium finance loan (step 225); and additional collateral may be optionally secured to cover any shortfalls between the loan balance and the policy cash surrender value (step 230). The additional collateral may be in any suitable form, such of a letter of credit 26 or other collateral such as cash. At step 235, longevity risk fund 28 may enter into collateral support agreement 30 with ILIT 12 through a credit source 32 (or directly, without source 32) to obtain the additional collateral. In some embodiments, fund 28 may enter into agreement 30 through a special purpose vehicle (SPV) such as a Delaware SPV which acts as credit source 32.

In exchange for providing the additional collateral fund 28 may receive compensation in the form of risk adjusted return on exposure (step 240). The compensation may be computed and paid from the net death benefits of the life insurance policy 16 after repaying the premium finance loan 20 based on a predetermined or pre-agreed formula.

Next, at step 245, fund 28 may receive structuring and other closing fees at the inception of the collateral support agreement 30. Upon the death of the insured, death benefit 34 may be paid to lender 22 (step 250); and subsequently used to repay the principal, interest and fees on the premium finance loan 20 (step 255).

At step 260, the remaining death benefit 34 may be allocated between longevity risk fund 28 and the ILIT 12, with the ILIT 12 paying the insured as further described herein; and at step 265, fund 28 receiving fees from ILIT 12 based on the value of collateral support agreement 30.

In one embodiment of the present invention, the systems and methods described herein may be implemented by one or more computing of processing systems. In such embodiments, the processing or computing system may be configured to: create a life insurance trust that holds a life insurance policy for an insured, electronically apply for and obtain the life insurance policy for the insured from an insurance company; electronically apply for and obtain a premium finance loan from a lender to finance the cost of the premiums of the life insurance policy, and hold premium finance loan in the trust; and pledge to the lender the life insurance policy as a collateral for the premium finance loan.

Upon the death of the insured, the system may further request and collect payment of the death benefit from insurer 18 and pay the proceeds to lender 22, ILIT 12, fund 28 and insured's beneficiaries as further described herein.

Further, the processing system may include a computer-readable medium or memory having stored therein computer-readable instructions for a processor. These instructions, when read and implemented by the processor, cause the processor to: input and store data pertaining to a life insurance policy; input and a store data pertaining to a premium finance loan from a lender, the premium finance loan configured to finance the cost of the premiums of the life insurance policy; input and store data pertaining to a trust that holds the life insurance policy and the premium finance loan; and input and store data pertaining to a pledge of the life insurance policy to the lender, as a collateral for the premium finance loan.

The instructions when executed by the processor may further cause the processor to: input and store data pertaining to additional collateral such as a letter of credit from a longevity risk fund that is provided by the trust to the lender as an additional collateral, wherein the letter of credit or other collateral is arranged to cover one or more shortfalls between the balance of the premium finance loan and the cash surrender value of the life insurance policy.

The instructions when executed by the processor may further cause the processor to: input and store data pertaining to a collateral support agreement that is entered into between the trust and the longevity risk fund, in order for the longevity risk fund to provide the letter of credit as an additional collateral for the premium finance loan.

The instructions when executed by the processor further cause the processor to: input and store data pertaining to a compensation paid by the trust to the longevity risk fund in exchange for the additional collateral provided by the longevity risk fund, and to compute the compensation from the net death benefits of the life insurance policy that remain after repayment of the premium finance loan. The instructions when executed by the processor further cause the processor to: allocate the death benefits that remain after repayment of the premium finance loan, between the trust and the longevity risk fund; and compute a minimum payment to be received by the longevity risk fund.

The computer-readable medium may be any medium known in the art, including but not limited to hard disks, floppy diskettes, CD-ROMs, flash memory, and optical storage devices. The computer readable instructions discussed above may be provided through software that is distributed through the Internet.

It should be noted that various changes and modifications to the presently preferred embodiments described herein will be apparent to those skilled in the art. Such changes and modifications may be made without departing from the spirit and scope of the present invention and without diminishing its attendant advantages.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

While the specification describes particular embodiments of the present invention, those of ordinary skill can devise variations of the present invention without departing from the inventive concept.

We claim:

1. A method for structuring investment vehicles that allow investors to securitize and invest in longevity risk and credit support obligations, comprising:
creating a life insurance trust that holds a life insurance policy for an insured;
obtaining a premium finance loan to finance the cost of the life insurance policy;
pledging to the lender the life insurance policy as a collateral for the loan;
providing credit support in connection with the premium finance loan pursuant to a collateral support agreement;
paying a death benefit associated with the life insurance policy to the life insurance trust upon the death of the insured; and
securitizing a cash flow expected to be received from providing credit support in connection with the premium finance.

2. The method of claim 1, further comprising securing additional collateral as an additional collateral for the premium finance loan.

3. The method of claim 2, wherein securing the additional collateral further comprises obtaining a letter of credit from a credit support provider.

4. The method of claim 3, wherein the additional collateral is arranged to cover one or more shortfalls between the balance of the loan and a cash surrender value of the life insurance policy.

5. The method of claim 3, wherein obtaining the additional collateral from the longevity risk fund comprises the life insurance trust entering into a collateral support agreement with the longevity risk fund.

6. The method of claim 5, wherein the additional collateral from the longevity risk fund is obtained directly or indirectly through a credit source.

7. The method of claim 5, wherein the credit source is a Delaware special purpose vehicle.

8. The method of claim 5, further comprising the life insurance trust paying a compensation to the longevity risk fund in exchange for the additional collateral provided by the longevity risk fund.

9. The method of claim 8, wherein the compensation is based, at least in part, on a risk-adjusted return on exposure.

10. The method of claim 8, wherein paying the compensation comprises computing the compensation based on a death benefit of the life insurance policy, after repaying the loan, based on a predetermined formula.

11. The method of claim 5, wherein the longevity risk fund receives structuring fees and closing fees at the inception of the collateral support agreement.

12. The method of claim 1, wherein the balance of the premium finance loan comprises one or more of the following: paid premiums of the life insurance policy, capitalized closing fees, and capitalized interest.

13. The method of claim 8 further comprising the life insurance trust paying to the lender the death benefit for the life insurance policy, upon death of the insured, and the lender using the death benefit to repay the principal, interest, and fees on the loan.

14. The method of claim 13, further comprising allocating remaining death benefits between the life insurance trust and the longevity risk fund.

15. The method of claim 14, wherein the life insurance trust pays at least a portion of the death benefit to the insured.

16. A computer-usable medium having stored therein computer-usable instructions for a processor, wherein instructions when executed by the processor cause the processor to:
input and store data pertaining to a life insurance policy;
input and a store data pertaining to a loan, wherein the loan is configured to finance the cost of the premiums of the life insurance policy;
input and store data pertaining to a life insurance trust that holds the life insurance policy and the loan;
input and store data pertaining to management of collateral support agreements and; and
input and store data pertaining to a pledge of the life insurance policy to the lender, as a collateral for the loan.

17. The computer-usable medium of claim 16, wherein the instructions when executed by the processor further cause the processor to:
input and store data pertaining to additional collateral that is provided by the life insurance trust to the lender;
wherein the additional collateral is arranged to cover one or more shortfalls between the balance of the loan and a cash surrender value of the life insurance policy.

18. The computer-usable medium of claim 17, wherein the instructions when executed by the processor further cause the processor to:
input and store data pertaining to a compensation paid by the life insurance trust to a longevity risk fund in exchange for the additional collateral.

19. The computer-usable medium of claim 16, wherein the instructions when executed by the processor further cause the processor to:
compute the compensation from a death benefit of the life insurance policy that remains after payment of the loan.

20. The computer-usable medium of claim 19, wherein the instructions when executed by the processor further cause the processor to:
allocate the death benefit that remains after payment of the premium finance loan, between the trust and the longevity risk fund; and
compute a payment to be received by the longevity risk fund.

21. The computer-usable medium of claim 20, wherein the instructions when executed by the processor further cause the processor to compute a payment to be received by an insured from the life insurance trust.

22. A system for structuring investment vehicles that allow investors to securitize and invest in longevity risk, comprising securitizing longevity risk comprising:
a processing system configured to:
create a life insurance trust that holds a life insurance policy for an insured;
obtain a premium finance loan from a lender to finance the cost of the premiums of the life insurance policy, and hold premium finance loan in the trust; and
pledge to the lender the life insurance policy as a collateral for the premium finance loan.

23. A system for structuring credit support commitments and securitizing longevity risk comprising:
a trust having a life insurance policy and a premium finance loan from a lender that finances the cost of the premiums of the life insurance policy; and
a longevity risk fund;
wherein the life insurance policy is pledged to the lender as collateral for the premium finance loan, further wherein the trust pledges an additional collateral to cover any shortfall between the balance and the cash surrender value of the life insurance policy; and
wherein the longevity risk fund is structured to provide the additional collateral for the trust.

24. The system of claim 23, wherein the longevity risk fund is further structured to provide the additional collateral by entering into a collateral support agreement with the trust through a credit source.

25. The system of claim 24, wherein the longevity risk fund is further structured to receive compensation from the trust in exchange for providing the additional collateral.

26. The system of claim 25, wherein the compensation comprises a risk adjusted return on exposure.

27. The system of claim 23 wherein the trust is structured to pay to the lender death benefits for the life insurance policy, upon death of the insured, so that the lender can use the death benefits to pay the principal, interest, and fees on the premium finance loan.

28. The system of claim 27, wherein the trust and the longevity risk fund are structured so that death benefits that remain after repayment of the principal, interest, and fees on the premium finance loan are allocated between the trust and the longevity risk fund, the longevity risk fund receiving a minimum payment.

29. The system of claim 28, wherein the longevity fund is further structured to receive from the trust fees that are based on the collateral support agreement and that are equal to the balance of the death benefits.

30. The system of claim 24, wherein the longevity fund securitizes cash flows the longevity fund expects to receive from the collateral support agreement.

31. The system of claim 30 wherein securitizing cash flows further comprises transferring credit support fees generated from the collateral support agreement to a bankruptcy-remote special purpose vehicle that issues securities to capital markets.
